(19) United States
(12) Patent Application Publication
(10) Pub. No.: US 2009/0025272 A1
(43) Pub. Date: Jan. 29, 2009

(54) FISHING BELT BUCKLE

(76) Inventors: Johnny Roy Redd, JR., Sanford, FL (US); Matthew S. Hughes, Winter Springs, FL (US)

Correspondence Address: Angela M. Miller, Esquire;Lowndes, Drosdick, Doster Kantor & Reed, P.A., P.O. Box 2809, Orlando, FL, 32802-2809, US

(21) Appl. No.: 11/828,190

(22) Filed: Jul. 25, 2007

(51) Int. Cl. A01K 97/10; A41F 19/00; A41F 1/00

(52) U.S. Cl. 43/21.2; 2/336; 224/922; 224/200

(57) ABSTRACT

A fishing belt buckle (1) having a body (2) with a front face (3), a rear face (4), a top face (5) and a bottom face (6), at least one recess (7) extending from the front face (3) into the body (2), at least one pin (13) located on and extending from the rear face (4) and an aperture (16) for attaching the body (2) to a belt (17). The recess (7) may include at least one vertical rod (12) and/or at least one horizontal rod (11) extending across the recess (7). To use the present invention, a person first attaches the fishing belt buckle (1) to a belt (17). Then, he or she wraps the belt (17) around his or her waist and positions the fishing belt buckle (2) as desired. The pin (13) is inserted into a belt hole (18) so as to secure the fishing belt buckle (2) and belt (17) around the user's waist.

### BACKGROUND OF THE INVENTION

This invention relates to fishing belt buckles, more particularly, a fishing belt buckle that permits a user to comfortably hold and retain a fishing rod against his or her stomach while at the same time permits the user to carry other items on his/her belt.

Oftentimes a fisherman or fisherwoman will place the end of the fishing rod handle against his or her stomach when reeling in a fish for several reasons. First, by positioning the rod handle against the stomach, the fisherman or fisherwoman acquires greater stability on the fishing rod. Second, the fisherman or fisherwoman achieves greater leverage for snapping back the rod, thereby ensuring the hook is firmly implanted into the fish's mouth. Finally, the positioning of the rod handle against the fisherman or fisherwoman's stomach permits the most efficient use of the fisherman or fisherwoman's energy by allowing him or her to conserve his or her energy when holding the rod and reeling in the line and expend his or her energy only during the active pulling on the line. However, because the end of the fishing rod handle digs into the fisherman or fisherwoman's stomach, it is uncomfortable to use such a method for fishing for an extended amount of time or when the catch is extremely large in size.

Currently, there are numerous fishing rod holders that permit a user to hold and retain a fishing rod comfortably against his/her stomach. The fishing rod holders, which essentially act as a shield between the fishing rod and the user's stomach, maintain the end of the fishing rod within the holder. Although they do provide a comfortable barrier between the end of the fishing rod and the user's stomach, oftentimes the fishing rod holders are so large and bulky in size that a person does not wear the holder on a continuous basis but rather straps on the holder only when he or she is reeling in a fish, thereby often not having the holder available when needed and requiring the assistance of a helper to put it on while trying to hold on to a fishing pole at the same time. In addition, as current fishing rod holders are positioned about a wearer's waist, usually over a belt, the wearer is usually not able to carry other items on his or her belt or, even if he or she is able to carry items on his or her belt, the items are not easily accessible for the user.

Thus, a need exists for a fishing belt buckle that permits a user to comfortably hold and retain a fishing rod against his or her stomach while at the same time permits the user to carry other items on his/her belt.

The relevant prior art includes the following references:

| Patent No. | | |
|---|---|---|
| (U.S. unless | | |
| stated otherwise) | Inventor | Issue/Publication Date |
| 3,782,613 | Davis | Jan. 01, 1974 |
| D447,981 | Chen | Sep. 18, 2001 |
| 3,885,721 | Vanus | May 27, 1975 |
| 5,992,814 | Allord | Nov. 30, 1999 |
| 4,562,620 | Oliver, Jr. | Jan. 07, 1986 |
| 5,105,574 | Fast | Apr. 21, 1992 |
| 5,687,890 | Wanner | Nov. 18, 1997 |
| 4,669,214 | Behrle | Jun. 02, 1987 |

### SUMMARY OF THE INVENTION

The primary object of the present invention is to provide a fishing belt buckle that permits a user to comfortably hold and retain a fishing rod against his or her stomach.

A further object of the present invention is to provide a fishing belt buckle that permits the user to carry items on his/her belt.

An even further object of the present invention is to provide a fishing belt buckle that is easy to use.

Another object of the present invention is to provide a fishing belt buckle that permits a person to retain fishing rods having various handle grooves.

The present invention fulfills the above and other objects by providing a fishing belt buckle having a body with a predetermined shape having a front face, a rear face, a top face and a bottom face, at least one fishing rod end retaining recess extending from the front face into the body, at least one belt-hole securing means located on and extending from the body rear face and a means for attaching the body to a belt. The recess is preferably round in shape and may include at least one vertical and/or at least one horizontal rod extending across the recess.

To use the present invention, a person first attaches the fishing belt buckle to a belt. In the alternative, the invention may be manufactured wherein the fishing belt buckle is already attached to a belt. Then, he or she wraps the belt around his or her waist and positions the fishing belt buckle as desired, which is preferably in alignment with the user's navel. Then, the belt-hole securing means is inserted into a hole located in the belt so as to secure the fishing belt buckle and belt around the user's waist. When desired, a person may then insert the handle of a fishing pole into the recess so as to gain additional stability and leverage when reeling in a catch. If the fishing rod handle includes grooves located on the handle base, the user may adjust the fishing rod handle such that the grooves correspond with the optional vertical and horizontal rods for greater stability and leverage, as well as to reduce the amount of spinning and twisting of the fishing rod within the recess.

The above and other objects, features and advantages of the present invention should become even more readily apparent to those skilled in the art upon a reading of the following detailed description in conjunction with the drawings wherein there is shown and described illustrative embodiments of the invention.

### BRIEF DESCRIPTION OF THE DRAWINGS

In the following detailed description, reference will be made to the attached drawings in which:

FIG. 1 is a front perspective view of a fishing belt buckle of the present invention;

FIG. 2 is a side view of the fishing belt buckle of the present invention;

FIG. 3 is a rear view of the fishing belt buckle of the present invention;

FIG. 4 is a front perspective view of a fishing belt buckle of the present invention having one fishing rod end retaining means;

FIG. 5 is a front perspective view of a fishing belt buckle of the present invention having no fishing rod end retaining means;

FIG. 6 is a top plan view of a fishing belt buckle of the present invention secured to a belt;

FIG. 7 is a top view of a fishing belt buckle of the present invention with an alternate belt-hole securing means; and

FIG. 8 is a front perspective plan view of a fishing belt buckle of the present invention in use.

### DESCRIPTION OF THE PREFERRED EMBODIMENTS

For purposes of describing the preferred embodiment, the terminology used in reference to the numbered components in the drawings is as follows:

| | |
|---|---|
| 1. | fishing belt buckle, generally |
| 2. | body |
| 3. | front face |
| 4. | rear face |
| 5. | top face |
| 6. | bottom face |
| 7. | recess |
| 8. | belt-hole securing means |
| 9. | means for attaching |
| 10. | fishing rod end retaining |
| | means |
| 11. | horizontal rod |
| 12. | vertical rod |
| 13. | pin |
| 14. | head |
| 15. | notch |
| 16. | aperture |
| 17. | belt |
| 18. | belt hole |
| 19. | fishing rod handle |
| 20. | fishing rod handle base |
| 21. | handle groove |

With reference to FIGS. 1-3, varying views of a fishing belt buckle of the present invention are shown. The fishing belt buckle, generally 1 of the present invention has a body 2 of a predetermined shape having a front face 3, a rear face 4, a top face 5 and a bottom face 6. The body 2 also includes at least one recess 7 of a predetermined shape, which is preferably round but which may be square, rectangular, triangular or any other shape, which extends from the front face 3 a predetermined distance into the body 2. Located within the recess 7 are fishing rod end retaining means 10 which may include at least one horizontal rod 11 and/or at least one vertical rod 12. The rods 11 and 12 extend across the recess 7 and may intersect with one another. The rods 11 and 12 may be permanently or removably secured within the recess 7.

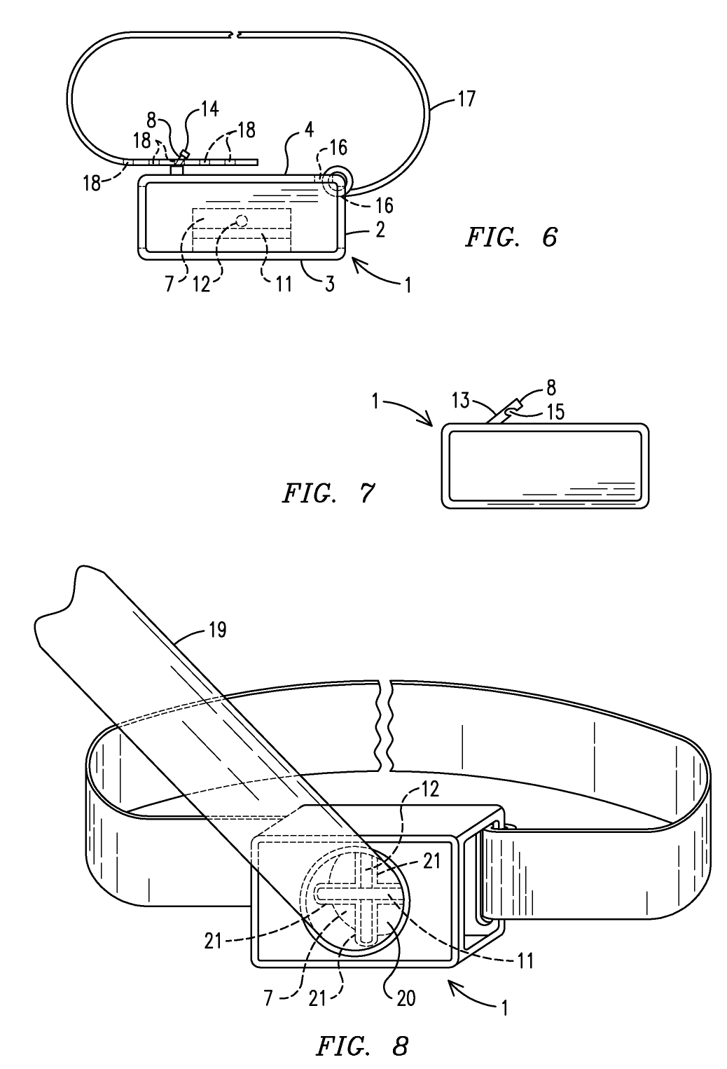

A means for attaching 9 the fishing belt buckle 1 to a belt 17 is preferably an aperture 16 located on the body 2 (see FIGS. 6 and 8). At least one belt-hole securing means 8, which is preferably a pin 13 having a head 14 but which may be any other type of extension, extends from the rear face 4 a predetermined distance.

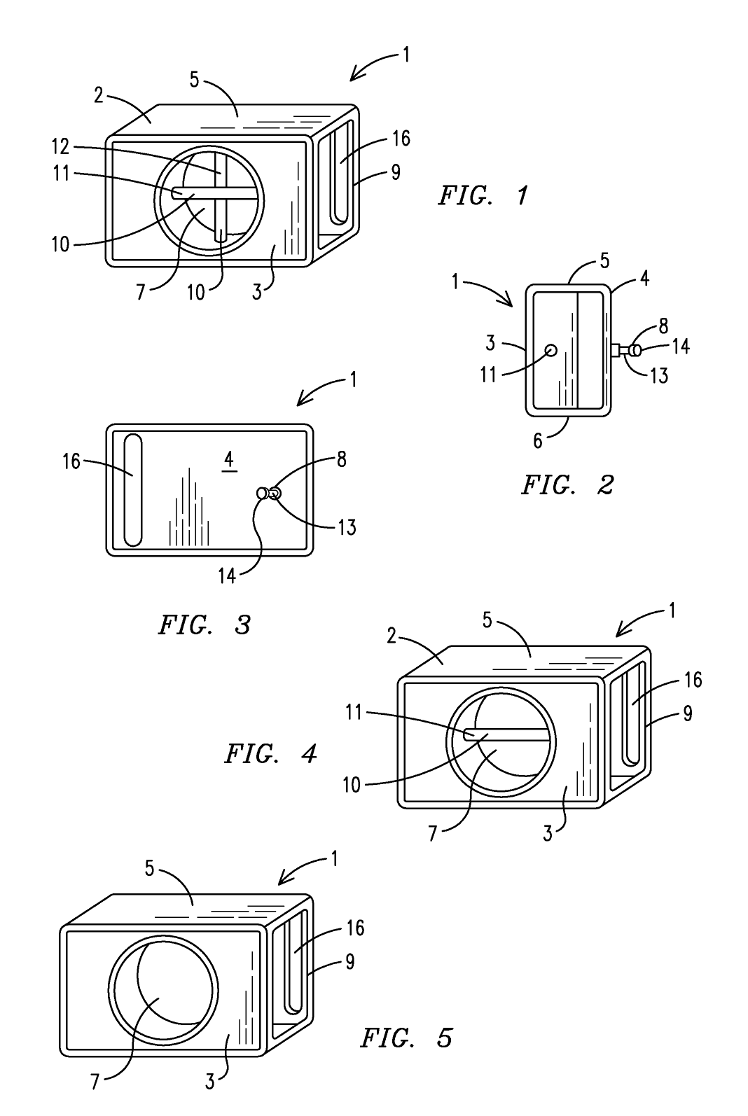

With reference to FIG. 4, a front perspective view of a fishing belt buckle of the present invention having one fishing rod end retaining means is shown. The fishing rod end retaining means 10 may be one horizontal rod 11 extending across the recess 7.

In FIG. 5, a front perspective view of a fishing belt buckle of the present invention having no fishing rod end retaining means is shown. The fishing belt buckle 1 still includes the recess 7; however, no fishing rod end retaining means are utilized. In this manner, a person may use a fishing pole having a handle with or without grooves located on the base of the handle.

FIG. 6 shows a top plan view of a fishing belt buckle of the present invention secured to a belt. The belt 17 is attached to the fishing belt buckle 1 by attaching the belt 17 through the aperture 16 located in the body 2. In the alternative, the fishing belt buckle 1 may be constructed so as the belt 17 is permanently attached to the fishing belt buckle 1. The body 2 is secured to the belt 17 by inserting the belt-hole securing means 8 through a belt hole 18 in the belt 17. Because the belt-hole securing means 8 preferably includes a head 14, the belt-hole securing means 8 is held securely within the belt hole 18.

In FIG. 7, a top view of a fishing belt buckle of the present invention with an alternate belt-hole securing means is shown. Rather than having a pin 13 with a head 14, the belt-hole securing means 8 may be a pin 13 with at least one notch 15 located thereon.

Finally, FIG. 8 shows a front perspective plan view of a fishing belt buckle of the present invention in use. The fishing belt buckle 1 is preferably positioned in alignment with a user's navel for optimum performance and secured about a user's waist by inserting the belt-hole securing means 8 into a belt hole 18 as shown in FIG. 6. When the fishing belt buckle 1 is positioned where desired, a user may then position a fishing rod handle 19 within the recess 7. Although not located on all fishing poles, some fishing rod handles 19 may include at least one groove 21 located on a fishing rod handle base 20. The at least one groove 21 may be vertical or horizontal. If utilizing a fishing pole having such a handle 19, a user may use the fishing rod end retaining means 10 located within the recess 7 to aid in stabilization of the fishing pole within the fishing belt buckle 1. For instance, if using a fishing rod handle 19 having intersecting grooves 21 as shown, the grooves 21 are positioned against the horizontal rod 11 and vertical rod 12 within the recess 7 of the fishing belt buckle 1.

The use of the present invention will allow a person to comfortably hold and retain a fishing rod against his or her stomach while at the same time permitting the user to carry other items on his/her belt.

It is to be understood that while a preferred embodiment of the invention is illustrated, it is not to be limited to the specific form or arrangement of parts herein described and shown. It will be apparent to those skilled in the art that various changes may be made without departing from the scope of the invention and the invention is not be considered limited to what is shown and described in the specification and drawings.

Having thus described my invention, I claim:

1. A fishing belt buckle comprising:
a body having a predetermined shape;
said body having a front face and a rear face;
said body having a top face and a bottom face;
at least one recess extending from said front face a predetermined distance into said body;
said at least one recess having a predetermined shape;
at least one belt-hole securing means located on said body rear face and extending a predetermined distance from said body rear face; and
a means for attaching said body to a belt.

2. The fishing belt buckle of claim 1 further comprising:
at least one fishing rod end retaining means located within said at least one recess.

3. The fishing belt buckle of claim 2 wherein:
said at least one fishing rod end retaining means is a horizontal rod.

4. The fishing belt buckle of claim 2 wherein:
said at least one fishing rod end retaining means is a vertical rod.

5. The fishing belt buckle of claim 1 wherein:
said at least one belt-hole securing means is a pin for insertion into a hole in a belt.

6. The fishing belt buckle of claim 2 wherein:
said at least one belt-hole securing means is a pin for insertion into a hole in a belt.

7. The fishing belt buckle of claim 5 further comprising:
at least one head located on said pin.

8. The fishing belt buckle of claim 5 further comprising:
at least one notch located on said pin.

9. The fishing belt buckle of claim 6 further comprising:
at least one head located on said pin.

10. The fishing belt buckle of claim 6 further comprising:
at least one notch located on said pin.

11. The fishing belt buckle of claim 1 wherein:
said means for attaching said body to a belt is an aperture located on said body.

12. The fishing belt buckle of claim 2 wherein:
said means for attaching said body to a belt is an aperture located on said body.

13. A fishing belt buckle comprising:
a body having a predetermined shape;
said body having a front face and a rear face;
said body having a top face and a bottom face;
at least one recess extending from said front face a predetermined distance into said body;
said at least one recess having a predetermined shape;
a horizontal rod located within said at least one recess;
at least one belt-hole securing means located on said body rear face and extending a predetermined distance from said body rear face; and
a means for attaching said body to a belt.

14. The fishing belt buckle of claim 13 further comprising:
a vertical rod located within said at least one recess.

15. The fishing belt buckle of claim 13 wherein:
said at least one belt-hole securing means is a pin for insertion into a hole in a belt.

16. The fishing belt buckle of claim 15 further comprising:
at least one head located on said pin.

17. The fishing belt buckle of claim 15 further comprising:
at least one notch located on said pin.

18. The fishing belt buckle of claim 15 wherein:
said means for attaching said body to a belt is an aperture located on said body.

19. A fishing belt buckle comprising:
a body having a predetermined shape;
said body having a front face and a rear face;
said body having a top face and a bottom face;
at least one recess extending from said front face a predetermined distance into said body;
said at least one recess having a round shape;
a horizontal rod located within said at least one recess;
a vertical rod located within said at least one recess;
a pin for insertion into a hole in a belt wherein said pin is located on said body rear face and extending a predetermined distance from said body rear face;
said pin having a head; and
an aperture located on said body for attaching said body to a belt.
